(19) United States
(12) Patent Application Publication
(10) Pub. No.: US 2018/0194019 A1
(43) Pub. Date: Jul. 12, 2018

(54) SHINGLE CUTTING TOOL

(71) Applicant: David Knox, Myrtle Creek, OR (US)

(72) Inventor: David Knox, Myrtle Creek, OR (US)

(21) Appl. No.: 15/400,165

(22) Filed: Jan. 6, 2017

(51) Int. Cl. B26B 7/00; B26B 5/00; E04D 15/02

(52) U.S. Cl. CPC B26B 7/00; E04D 15/02; B26B 5/00

(57) ABSTRACT

Cutting blades for use with oscillating tools including a top edge, a bottom edge opposite the top edge, a first surface, a second surface opposite the first surface, an attachment end where the attachment end is configured to attach to an oscillating tool, a cutting end opposite the attachment end where the cutting end is hook-shaped and where the cutting end also includes a notch, where the notch extends inwardly from the bottom edge to form the hook-shape and define a cutting area to accept material to be cut, and where the notch further includes a cutting edge to cut material inserted into the notch.

### BACKGROUND

The present disclosure relates generally to oscillating tools. In particular, cutting blades for use with oscillating tools in order to more easily and effectively cut asphalt roof shingles are described. The cutting blades may be attachable and interchangeable with most common oscillating tools using a universal attachment.

Known tools and methods for cutting asphalt roof shingles are not entirely satisfactory for the range of applications in which they are employed. For example, existing tools for cutting asphalt shingles consist of a knife, box cutter, or other hand-held mechanical blade. A user takes the blade in hand and runs the blade over the shingle. Hopefully, with enough pressure and a sharp enough blade, the asphalt roof shingle will cut and separate. However, this process may be slow and time consuming, as each cut takes time, and may also take more than one pass with a knife or blade. Additionally, a user may tire from the constant pushing and slicing necessary to make the cut, and not to mention the constant hunched over posture that one often does when cutting roofing shingles.

Thus, there exists a need for cutting blades that improve upon and advance the design of known tools and methods for cutting asphalt shingles. Examples of new and useful cutting blades relevant to the needs existing in the field are discussed below.

### SUMMARY

The present disclosure is directed to cutting blades for use with oscillating tools. In some examples, the blades include a top edge, a bottom edge opposite the top edge, a first surface, a second surface opposite the first surface, an attachment end where the attachment end is configured to attach to an oscillating tool, and a cutting end opposite the attachment end, where the cutting end is hook-shaped. The cutting end may also include a notch, where the notch extends inwardly from the bottom edge to form the hook-shape and defining a cutting area configured to accept material to be cut. The notch may further include a cutting edge configured to cut material inserted into the notch.

In some examples, the blade may include a tip, the tip being formed by the bottom edge and the notch and configured to guide material into the notch. The tip may be rounded and configured to easily slide over material and have material easily slid over the tip into the notch. Alternatively, the tip may be pointed and configured to easily grab material. The cutting edge may be a chisel edge, where the chisel edge includes a tapered slope extending from the first surface to the second surface to form a sharpened point. Alternatively, the cutting edge may be a v-edge, where the v-edge includes a tapered negative slope extending approximately halfway from the first surface to the second surface, and tapered positive slope extending approximately halfway from the second surface to the first surface, where the tapered negative slope and the tapered positive slope form a sharpened point that is approximately halfway between the first surface and the second surface.

Further, the attachment end is comprised of a universal quick fit attachment, where the universal quick fit attachment is a standard design for oscillating tool attachments and allows for the blade to attach to most hand-held oscillating tools. The notch may also include an entry angle, where the entry angle is an angle formed between the bottom edge and the notch. The entry angle may be an angle between 15 and 85 degrees. Specifically, the entry angle may be 45 degrees. The notch may also include a depth, the depth being the distance the notch extends from the bottom edge toward the top edge. The depth may be 50% or more of the distance from the bottom edge toward the top edge.

In other examples, there is a system for cutting asphalt shingles, the system including an oscillating tool and a blade. The blade may include a top edge, a bottom edge opposite the top edge, a first surface, a second surface opposite the first surface, an attachment end where the attachment end is configured to attach to an oscillating tool, and a cutting end where the cutting end is hook-shaped. The cutting end may also include a notch, where the notch extends inwardly from the bottom edge to form the hook-shape and defining a cutting area configured to accept material to be cut. The notch may also include a cutting edge configured to cut material inserted into the notch. There may be a raised portion of the blade at the attachment end, and a riser portion that raises the attachment end away from the rest of the blade.

In some examples, the blade may include a tip, the tip being formed by the bottom edge and the notch and configured to guide material into the notch. The tip may be rounded and configured to easily slide over material and have material easily slid over the tip into the notch. Alternatively, the tip may be pointed and configured to easily grab material. The cutting edge may be a chisel edge, where the chisel edge includes a tapered slope extending from the first surface to the second surface to form a sharpened point. Alternatively, the cutting edge may be a v-edge, where the v-edge includes a tapered negative slope extending approximately halfway from the first surface to the second surface, and tapered positive slope extending approximately halfway from the second surface to the first surface, where the tapered negative slope and the tapered positive slope form a sharpened point that is approximately halfway between the first surface and the second surface.

Further, the attachment end is comprised of a universal quick fit attachment, where the universal quick fit attachment is a standard design for oscillating tool attachments and allows for the blade to attach to most hand-held oscillating tools. The notch may also include an entry angle, where the entry angle is an angle formed between the bottom edge and the notch. The entry angle may be an angle between 15 and 85 degrees. Specifically, the entry angle may be 45 degrees. The notch may also include a depth, the depth being the distance the notch extends from the bottom edge toward the top edge. The depth may be less than 50% of the distance from the bottom edge toward the top edge.

### BRIEF DESCRIPTION OF THE DRAWINGS

FIG. 1 is a perspective view of a first example of a cutting blade attached to an oscillating tool.

FIG. 2 is a top view of the cutting blade shown in FIG. 1 depicting an oblong and hook-shape of the cutting blade.

FIG. 3 is a perspective view of the cutting blade shown in FIG. 1, depicting a flat or planar cutting blade.

FIG. 4 is a cross section of the cutting blade shown in FIG. 1, depicting a cross section of the hook-shape and a chisel edge of the cutting blade.

FIG. 5 is a perspective view of a second example of a cutting blade including a raised portion of the blade, where the blade also includes a sharp tip and short notch.

FIG. 6 is cross section of the cutting blade shown in FIG. 5, depicting a cross section of the hook-shape and a V-edge of the cutting blade.

### DETAILED DESCRIPTION

The disclosed cutting blade for use with oscillating tools will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various cutting blades are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

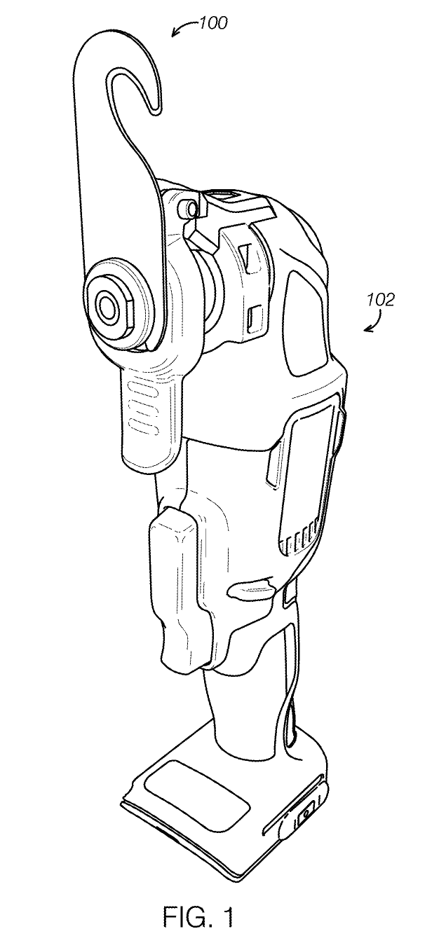

With reference to FIGS. 1-4, a first example of a cutting blade, blade 100, will now be described. As can be seen in FIG. 1, blade 100 functions to attach to an oscillating tool 102. The blade 100 oscillates rapidly to precisely cut a material or object, and in particular asphalt roofing shingles, when that material or object is placed in the hook-shaped blade 100 and pressed against blade 100. In particular, blade 100 is intended to be used elevated above a surface by a user, or while placed on top of a surface or material to precisely cut asphalt roofing shingles. The reader will appreciate from the figures and description below that blade 100 addresses shortcomings of conventional tools and methods for cutting asphalt roofing shingles.

For example, blade 100 may be used with common power tools, in particular, oscillating power tools to quickly and efficiently cut asphalt roofing shingles without tiring or straining a user. The user of blade 100 with an oscillating tool does not need to press firmly with a knife or cutting blade. Instead, the rapid oscillation of blade 100 will quickly cut an asphalt roofing shingle with only a minimal amount of pressure as a user pulls the oscillating tool and blade through the asphalt shingle. A user may place blade 100 on a surface, and while guiding the asphalt shingle carefully into blade 100, may pull the oscillating tool over the surface, effectively cutting the asphalt shingle. This may be done by a user standing up as well, elevating the tool and blade above a material or surface to cut an asphalt shingle, as the user no longer needs to apply a downward force or pressure to the shingle to cut it. Overall, using blade 100 saves a user time and energy while cutting asphalt roofing shingles.

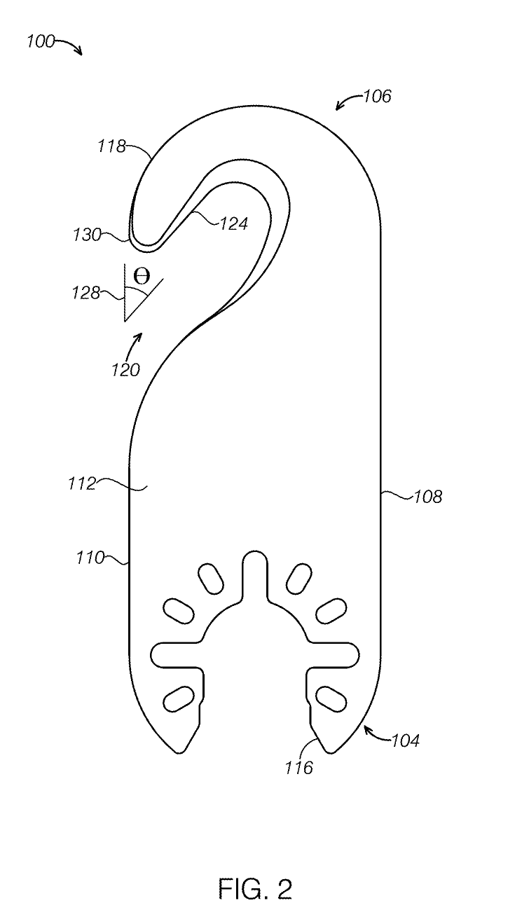

Turning to FIG. 2, blade 100 may include an attachment end 104 for attachment to an oscillating tool, and a cutting end 106 for cutting a material, including roofing shingles. Blade 100 may also include a top edge 108, a bottom edge 110, a first surface 112, and a second surface 114. In this example embodiment, blade 100 is substantially hook-shaped, where the cutting end 106 forms the hook-shape. Additionally, blade 100 is substantially planar or flat. In alternate example embodiments, the blade may include raised portions, differing shapes, or alternate angles.

As seen in FIG. 2, blade 100 may have an oblong shape that is substantially rectangular with rounded ends, where the attachment end 104 is located at one end of the elongated shape, and the cutting end 106 is located at the opposite end of the elongated shape. The top edge 108 may be located along one edge of the elongated shape of blade 100, and the bottom edge 110 may be located opposite of the top edge 108 along another edge of the elongated shape of blade 100. It will be appreciated that the top edge and bottom edge may be any suitable length, and any features located along either top edge 108 or bottom edge 110 may be interchangeable with one another.

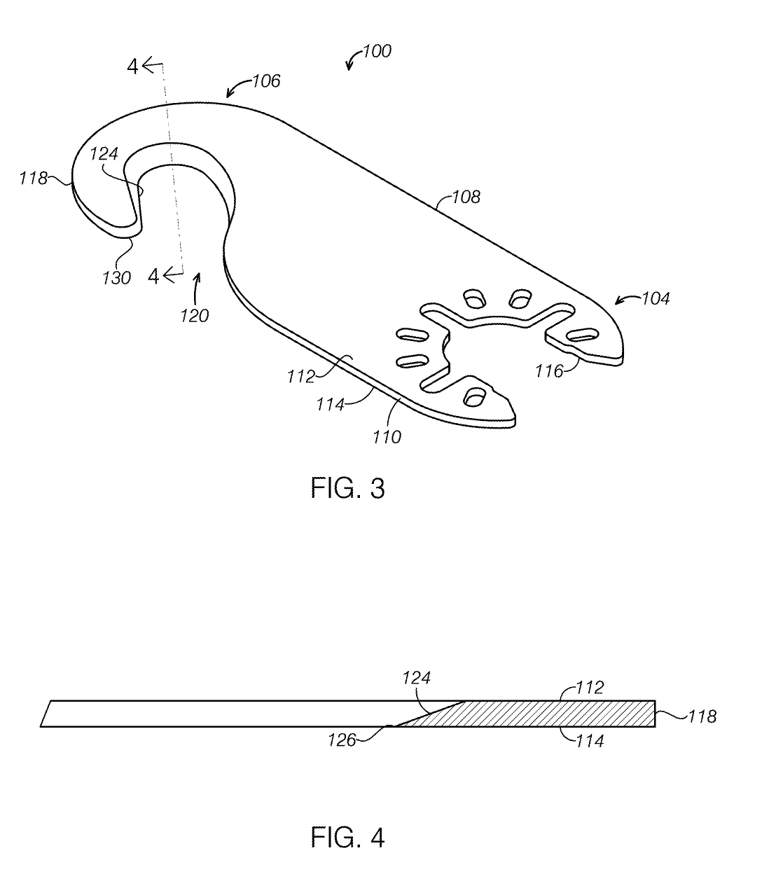

Referring to FIG. 3, blade 100 may also have a first surface 112 and a second surface 114, where first surface 112 and second surface 114 are separated by a thickness of blade 100. The thickness of blade 100 may be of any suitable thickness such that blade 100 may be able to cut roof shingles effectively and efficiently without damaging either the roof shingles or blade 100. In this example embodiment, blade 100 may have a thickness of a range between 0.25 millimeters and 2 millimeters. This thickness allows for blade 100 to track more precisely as it cuts a material, and in particular roof shingles. It will be appreciated that any features located on or associated with either the first surface 112 and the second surface 114 may be interchangeable with one another.

Referring again to FIG. 2, the attachment end 104 may be located at one end of the elongated shape of blade 100, and may feature an attachment mechanism 116 to attach blade 100 to an oscillating tool. In this example embodiment, the attachment mechanism 116 of blade 100 may include a universal quick fit attachment. The universal quick fit attachment is a standard design for oscillating tool attachments, and allows for compatibility with most oscillating tool brands. The universal quick fit attachment of this example is a star or plus shaped stamp in blade 100, where the stamp is a hole that extends through blade 100 from first surface 112 to second surface 114. In alternate examples, the attachment mechanism 116 may be a screw or threaded hole that may facilitate attachment to an oscillating tool. Still in alternate examples, the attachment mechanism 116 may include a clamp or other coupling device on blade 100 to attach blade 100 to any other tool.

Still referring to FIG. 2, the cutting end 106 may be located at one end of the elongated shape of blade 100. In this example embodiment, cutting end 106 is located at an opposite end of the attachment end 104. The cutting end 106 may be hook-shaped, where the end of blade 100 includes a curve 118. Curve 118 functions to act as a point for blade 100 to rest as it is pulled over a surface as it cuts asphalt roofing shingles. In addition, curve 118 adds safety to blade 100 by removing sharp edges or corners that may injure a user.

As seen in FIG. 2, cutting end 106 may also include a notch 120. Notch 120 may be a gap, indentation, or other similar void in blade 100 which extends inwards from an edge to form the shape of a hook. In this example embodiment, notch 120 extends inwardly from bottom edge 110 to form a cutting area 122 where material may be inserted to be cut by blade 100. The cutting area 122 in this example embodiment is an elongated and rounded shape in order to allow cutting on part of the rounded portion of the cutting area 122. The notch 120 may extend inward from an edge to a certain depth. The depth may be the distance the notch extends from the bottom edge 110 toward the top edge 108. In this example embodiment, the depth is approximately 50%, or half the distance as measured from the bottom edge 110 to the top edge 108. In alternate embodiments, the depth may be more than 50% of the distance from the bottom edge 110 to the top edge 108.

As can be seen in FIGS. 2-4, the notch 120 may include a cutting edge 124 which is sharpened to a point 126, or otherwise made to cut material. Cutting edge 124 may have a tapered slop extending from side to another to form the sharpened point. In this example embodiment, cutting edge 124 forms a chisel edge and includes a tapered negative slope extending from the first surface 112 of blade 100 to the second surface 114 of blade 100, such that there is a sharpened point 126 of the cutting edge 124 at the second surface 114. In alternate examples, the cutting edge 124 includes a tapered positive slope extending from the second surface 114 to the first surface 112 of blade 100, such that there is a sharpened point at the first surface 112. Additionally, in alternate embodiments, cutting edge 124 may be any edge capable of cutting material, and may include a serrated edge, V-edge, hollow edge, compound bevel edge, or convex edge.

Referring back to FIG. 2, notch 120 and bottom edge 110 of blade 100 may form an entry angle 128. Entry angle 128 for the notch 120 may determine at what angle an oscillating tool may be held at in relation to the material being cut in order to allow for a user to properly cut the material. The entry angle 128 may also determine how a user must use the oscillating tool in order to cut the material. In this example embodiment, the entry angle 128 may be at 45 degrees. In alternate embodiments, the entry angle may be at any angle, and more specifically any effective angle within a range of 15 degrees and 85 degrees in order to allow a user to pull the oscillating tool towards them in order to cut the material. In alternate embodiments of the invention, the entry angle may include a range of 105 degrees to 165 degrees in order to allow a user to push the oscillating tool away from them in order to cut the material.

As seen in FIG. 3, the notch 120 and bottom edge 110 may additionally form a tip 130. Tip 130 assists the cutting process of blade 100 by guiding material into the notch 120 to be cut while separating out other material not intended to be cut. A user may rest the tip 130 and the bottom edge 110 near the tip 130 on a surface and slide blade 100 and the oscillating tool along the surface, guiding material into the notch 120 to be cut. In this example embodiment, the tip 130 is rounded. The rounded tip 130 allows for blade 100 to easily be slid over a surface or material without catching the surface or material as blade 100 cuts other material or roof shingles. Alternatively, the material to be cut may be slid into the notch 120, and the rounded tip 130 allows for that material to be cut to be easily slid over blade 100 without catching.

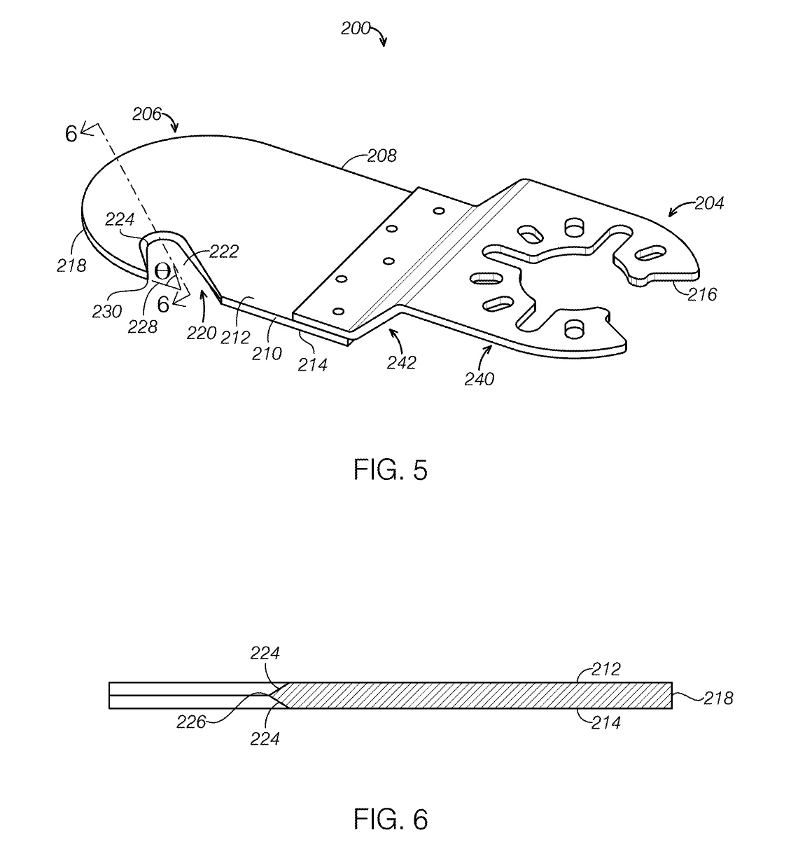

Turning attention to FIGS. 5-6, a second example of a cutting blade, blade 200, will now be described. Blade 200 includes many similar or identical features to blade 100. Thus, for the sake of brevity, each feature of blade 200 will not be redundantly explained. Rather, key distinctions between blade 200 and blade 100 will be described in detail and the reader should reference the discussion above for features substantially similar between the two blades.

As can be seen in FIG. 5, blade 200 may include an attachment end 204 for attachment to an oscillating tool, and a cutting end 206 for cutting a material, including roofing shingles. Blade 200 may also include a top edge 208, a bottom edge 210, a first surface 212, and a second surface 214. In this second example embodiment, blade 200 is substantially hook-shaped, where the cutting end 206 forms the hook-shape, where the hook shape is smaller than that of previous example embodiments. Additionally, blade 200 includes a raised portion 240 and riser portion 242, where the raised portion 240 may be situated at one end of blade 200 and where the riser portion 242 elevates the raised portion 240 away from the rest of blade 200.

As seen in FIG. 5, blade 200 may have an oblong shape that is substantially rectangular with rounded ends, where the attachment end 204 is located at one end of the elongated shape, and the cutting end 206 is located at the opposite end of the elongated shape. In this second example embodiment, the raised portion 240 is situated at the attachment end 204 of blade 200. In alternate embodiments, the raised portion 240 may be situated at the cutting end 206 of blade 200. The top edge 208 may be located along one edge of the elongated shape of blade 200, and the bottom edge 210 may be located opposite of the top edge 208 along another edge of the elongated shape of blade 200. It will be appreciated that the top edge and bottom edge may be any suitable length, and any features located along either top edge 208 or bottom edge 210 may be interchangeable with one another.

Still as seen in FIG. 5, blade 200 may also have a first surface 212 and a second surface 214, where first surface 212 and second surface 214 are separated by a thickness of blade 200. The attachment end 204 may be located at one end of the elongated shape of blade 200, and may feature an attachment mechanism 216 to attach blade 200 to an oscillating tool. In this example embodiment, the attachment mechanism 216 of blade 200 may include a universal quick fit attachment. In alternate examples, the attachment mechanism 216 may be a screw or threaded hole that may facilitate attachment to an oscillating tool. Still in alternate examples, the attachment mechanism 216 may include a clamp or other coupling device on blade 200 to attach blade 200 to any other tool.

Still referring to FIG. 5, the cutting end 206 may be located at one end of the elongated shape of blade 200. In this example embodiment, cutting end 206 is located at an opposite end of the attachment end 204. The cutting end 206 may be hook-shaped, where the end of blade 200 includes a curve 218. Cutting end 206 may also include a notch 220. Notch 220 may be a gap, indentation, or other similar void in blade 200 which extends inwards from an edge to form the shape of a hook. In this example embodiment, notch 220 extends inwardly from bottom edge 210 to form a cutting area 222 where material may be inserted to be cut by blade 200. The cutting area 222 in this example embodiment is an elongated and rounded shape in order to allow cutting on part of the rounded portion of the cutting area 222. The notch 220 may extend inward from an edge to a certain depth. The depth may be the distance the notch extends from the bottom edge 210 toward the top edge 208. In this example embodiment, the depth is approximately 25%, or one quarter the distance as measured from the bottom edge 210 to the top edge 208. In alternate embodiments, the depth may be any depth less than 50% of the distance from the bottom edge 210 to the top edge 208.

Referring to FIG. 6, the notch 220 may include a cutting edge 224 which is sharpened to a point, or otherwise made to cut material. Cutting edge 224 may have a tapered slop extending from side to another to form the sharpened point. In this example embodiment, cutting edge 224 forms a V-edge. The V-edge includes a tapered negative slope extending approximately halfway from the first surface 212 to the second surface 214, and a tapered positive slope extending approximately halfway from the second surface 214 to the first surface 212. The tapered negative slope and the tapered positive slope form a sharpened point 226 approximately halfway between the first surface 212 and second surface 214.

Referring back to FIG. 5, notch 220 and bottom edge 210 of blade 200 may form an entry angle 228. The entry angle 228 is an angle formed between the bottom edge 210 and the notch 220. In this example embodiment, the entry angle 228 may be at 45 degrees. In alternate embodiments, the entry angle may be at any angle, and more specifically any effective angle within a range of 15 degrees and 85 degrees in order to allow a user to pull the oscillating tool towards them in order to cut the material. In alternate embodiments of the invention, the entry angle may include a range of 105 degrees to 165 degrees in order to allow a user to push the oscillating tool away from them in order to cut the material.

As seen in FIG. 5, the notch 220 and bottom edge 210 may additionally form a tip 230. Tip 230 assists the cutting process of blade 200 by guiding material into the notch 220 to be cut. In this example embodiment, the tip 230 is pointed. The pointed tip 230 allows for blade 200 to easily grab material. The pointed tip 230 may also allow for the blade 200 to be guided as material is being cut.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A cutting blade for use with oscillating tools, the blade comprising:
a top edge;
a bottom edge opposite the top edge;
a first surface;
a second surface opposite the first surface;
an attachment end, where the attachment end is configured to attach to an oscillating tool;
a cutting end opposite the attachment end, where the cutting end is hook-shaped, cutting end also including;
a notch, where the notch extends inwardly from the bottom edge to form the hook-shape and defining a cutting area configured to accept material to be cut, the notch further including a cutting edge configured to cut material inserted into the notch.

2. The blade of claim 1, further comprising;
a tip, the tip being formed by the bottom edge and the notch and configured to guide material into the notch.

3. The blade of claim 2, wherein the tip is rounded and configured to easily slide over material and have material easily slid over the tip into the notch.

4. The blade of claim 2, wherein the tip is pointed and configured to easily grab material.

5. The blade of claim 1, wherein the cutting edge is a chisel edge, where the chisel edge includes a tapered slope extending from the first surface to the second surface to form a sharpened point.

6. The blade of claim 1, wherein the cutting edge is a v-edge, where the v-edge includes a tapered negative slope extending approximately halfway from the first surface to the second surface, and tapered positive slope extending approximately halfway from the second surface to the first surface, where the tapered negative slope and the tapered positive slope form a sharpened point that is approximately halfway between the first surface and the second surface.

7. The blade of claim 1, wherein the attachment end is comprised of a universal quick fit attachment, where the universal quick fit attachment is a standard design for oscillating tool attachments and allows for the blade to attach to most hand-held oscillating tools.

8. The blade of claim 1, wherein the notch further comprises:
an entry angle, where the entry angle is an angle formed between the bottom edge and the notch, and wherein the entry angle is an angle between 15 and 85 degrees.

9. The blade of claim 8, wherein the entry angle is 45 degrees.

10. The blade of claim 1, wherein the notch includes a depth, the depth being the distance the notch extends from the bottom edge toward the top edge, and wherein the depth is 50% or more of the distance from the bottom edge toward the top edge.

11. A system for cutting asphalt shingle, the system comprising:
an oscillating tool and a blade, the blade comprising;
a top edge;
a bottom edge opposite the top edge;
a first surface;
a second surface opposite the first surface;
an attachment end, where the attachment end is configured to attach to an oscillating tool;
a cutting end opposite the attachment end, where the cutting end is hook-shaped, cutting end also including;
a notch, where the notch extends inwardly from the bottom edge to form the hook-shape and defining a cutting area configured to accept material to be cut, the notch further including a cutting edge configured to cut material inserted into the notch;
a raised portion at the attachment end; and
a riser portion configured to raise the attachment end and the raised portion away from the rest of the blade.

12. The system of claim 11, the blade further comprising;
a tip, the tip being formed by the bottom edge and the notch and configured to guide material into the notch.

13. The system of claim 12, wherein the tip is rounded and configured to easily slide over material and have material easily slid over the tip into the notch.

14. The system of claim 12, wherein the tip is pointed and configured to easily grab material.

15. The system of claim 11, wherein the cutting edge is a chisel edge, where the chisel edge includes a tapered slope extending from the first surface to the second surface to form a sharpened point.

16. The system of claim 11, wherein the cutting edge is a v-edge, where the v-edge includes a tapered negative slope extending approximately halfway from the first surface to the second surface, and tapered positive slope extending approximately halfway from the second surface to the first surface, where the tapered negative slope and the tapered positive slope form a sharpened point that is approximately halfway between the first surface and the second surface.

17. The system of claim 11, wherein the attachment end is comprised of a universal quick fit attachment, where the universal quick fit attachment is a standard design for oscillating tool attachments and allows for the blade to attach to most hand-held oscillating tools.

18. The system of claim 11, wherein the notch further comprises:
an entry angle, where the entry angle is an angle formed between the bottom edge and the notch, and wherein the entry angle is an angle between 15 and 85 degrees.

19. The system of claim 18, wherein the entry angle is 45 degrees.

20. The system of claim 11, wherein the notch includes a depth, the depth being the distance the notch extends from the bottom edge toward the top edge, and wherein the depth is less than 50% of the distance from the bottom edge toward the top edge.
